(19) United States
(12) Patent Application Publication
(10) Pub. No.: US 2024/0332844 A1
(43) Pub. Date: Oct. 3, 2024

(54) TERMINAL HAVING STAMPING ELASTIC SHEET STRUCTURE

(71) Applicant: Changchun Jetty Automotive Technology Co., Ltd., Changchun, Jilin Province (CN)

(72) Inventors: Chao WANG, Changchun (CN); Yun MIAO, Changchun (CN)

(21) Appl. No.: 18/579,681

(22) PCT Filed: Jul. 15, 2022
(86) PCT No.: PCT/CN2022/105970

§ 371 Date: Jan. 16, 2024

(30) Foreign Application Priority Data
Jul. 15, 2021 (CN) 202110803160.X
Jul. 15, 2021 (CN) 202121611169.2

(51) Int. Cl. H01R 13/11

(52) U.S. Cl. CPC H01R 13/111

(57) ABSTRACT

A terminal having a stamping elastic sheet structure, including a mounting base (1) and an outer elastic sheet structure (2). An end of the outer elastic sheet structure (2) is connected to an end of the mounting base (1). The mounting base (1) and the outer elastic sheet structure (2) are formed separately, and the outer elastic sheet structure (2) is formed by stamping. The terminal having the stamping elastic sheet structure is formed by assembling a stamping elastic sheet and a mounting base that are separately machined and manufactured, instead of integral machining, so as to greatly reduce the cost of the terminal, reduce the machining time, ensure a sufficient contact between the elastic sheet and a conductive portion of a mating terminal, and meet the mechanical demand and the temperature rise requirement of a charging system.

### RELATED APPLICATION

The present disclosure claims priority to Chinese Invention Patent Application No. 202110803160.X filed on Jul. 15, 2021 and Chinese Utility Model Patent Application No. 202121611169.2 filed on Jul. 15, 2021, which are hereby incorporated by reference in their entireties.

### TECHNICAL FIELD

The present disclosure relates to a terminal having a stamping elastic sheet structure.

### BACKGROUND

Due to high voltage and large current, cables of electric vehicles need to use large-diameter wires for current conduction. At present, terminals of charging guns and charging sockets are all formed by integral machining of copper. The disadvantages are that the cost is high, the machining time is long, and the terminal can only be replaced as a whole when damaged, which is not conducive to the cost control of the charging system.

### SUMMARY

In order to reduce the manufacturing cost of a charging terminal, the present disclosure provides a terminal having a stamping elastic sheet structure, which is formed by assembling a stamping elastic sheet and a mounting base that are separately machined and manufactured, instead of integral machining, so as to greatly reduce the cost of the terminal, reduce the machining time, ensure a sufficient contact between the elastic sheet and a conductive portion of a mating terminal, and meet the mechanical demand and the temperature rise requirement of a charging system.

The present disclosure adopts the following technical solution to solve the technical problem:
a terminal having a stamping elastic sheet structure, including a mounting base and an outer elastic sheet structure. An end of the outer elastic sheet structure is connected to an end of the mounting base, the mounting base and the outer elastic sheet structure are formed separately, and the outer elastic sheet structure is formed by stamping.

The present disclosure has the following advantageous effects:
1. The stamping elastic sheet, which may be the outer elastic sheet structure or the inner elastic sheet structure, and the mounting base are separately machined and manufactured and then assembled into a whole, so that the charging terminal does not need to be integrally machined, which saves the machining time and material.
2. The stamping elastic sheet is manufactured by stamping, which is a simple machining mode and needs less working hours, and can retain the conductive and elastic properties of the material.
3. For the terminal with a damaged stamping elastic sheet, only the stamping elastic sheet needs to be replaced, instead of replacing the whole terminal, thereby saving the terminal and maintenance cost.

### BRIEF DESCRIPTION OF DRAWINGS

The drawings illustrated here are intended to provide a further understanding of the present disclosure, and constitute a part of the present disclosure rather than limitations thereto. In the drawings:

FIG. 1 illustrates a stereoscopic diagram of a terminal having a stamping elastic sheet structure according to a first embodiment of the present disclosure.

FIG. 2 illustrates a front view of a terminal having a stamping elastic sheet structure according to the first embodiment of the present disclosure.

FIG. 3 illustrates a schematic diagram of an outer elastic sheet structure and a mounting base that are connected by a first connection mode according to the first embodiment.

FIG. 4 illustrates a schematic diagram of an outer elastic sheet structure and a mounting base that are connected by a second connection mode according to the first embodiment.

FIG. 5 illustrates a schematic diagram of an outer elastic sheet structure and a mounting base that are connected by a third connection mode according to the first embodiment.

FIG. 6 illustrates a schematic diagram of a first type of an outer elastic sheet structure in a planar unfolded state according to the first embodiment.

FIG. 7 illustrates a front view of an outer elastic sheet strip of a second type of an outer elastic sheet structure according to the first embodiment.

FIG. 8 illustrates a stereoscopic diagram of an outer elastic sheet strip of the second type of the outer elastic sheet structure according to the first embodiment.

FIG. 9 illustrates a schematic diagram of a second type of an outer elastic sheet structure in a planar unfolded state according to the first embodiment.

FIG. 10 illustrates a stereoscopic diagram of a terminal having a stamping elastic sheet structure according to a second embodiment of the present disclosure.

FIG. 11 illustrates a cross-sectional view of the terminal having a stamping elastic sheet structure according to the second embodiment of the present disclosure.

FIG. 12 illustrates a cross-sectional view of an inner elastic sheet structure according to the second embodiment.

FIG. 13 illustrates a schematic diagram of a first type of an inner elastic sheet structure according to the second embodiment.

FIG. 14 illustrates a schematic diagram of a second type of an inner elastic sheet structure according to the second embodiment.

### DETAILED DESCRIPTION OF EMBODIMENTS

For a clearer understanding of the objectives, technical features and effects of the embodiments of the present disclosure, specific embodiments will now be described with reference to the drawings. The described embodiments are intended only to schematically illustrate and explain this invention and do not limit the scope of the present disclosure.

### First Embodiment

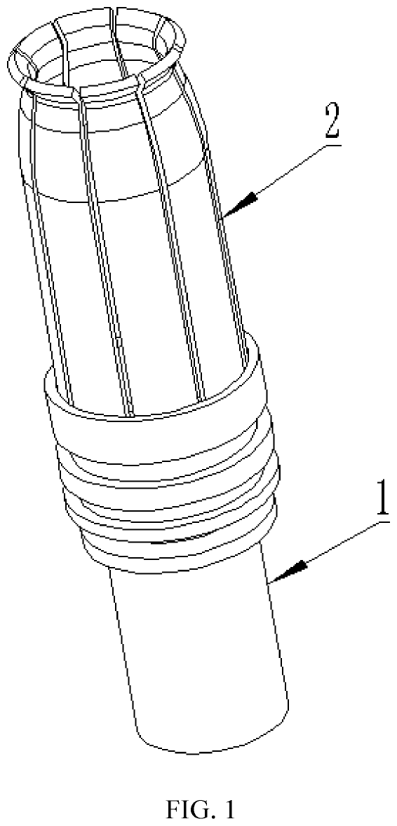

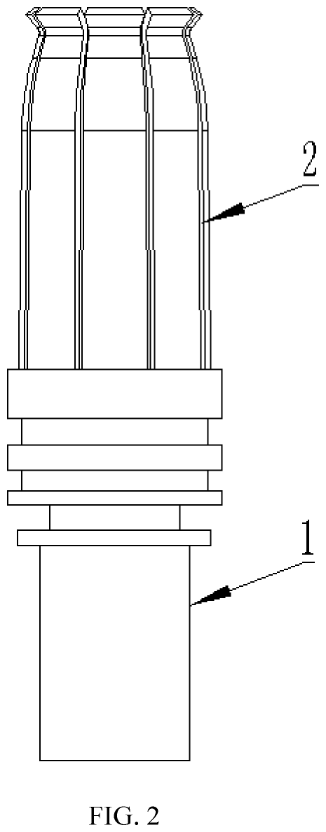

An embodiment of the present disclosure provides a terminal having a stamping elastic sheet structure, and the terminal includes a mounting base 1 and an outer elastic sheet structure 2. An end of the outer elastic sheet structure 2 is connected to an end of the mounting base 1, the mounting base 1 and the outer elastic sheet structure 2 are formed separately, and the outer elastic sheet structure 2 is formed by stamping, as illustrated in FIGS. 1 to 3.

The mounting base 1 and the outer elastic sheet structure 2 are respectively machined and formed firstly, and then assembled into a whole to finally form the terminal having a stamping elastic sheet structure, thereby greatly reducing the terminal cost, reducing the machining time, and ensuring a sufficient contact between the elastic sheet and a conductive part of a mating terminal.

In this embodiment, the outer elastic sheet structure 2 is barrel-shaped, and includes, in a circumferential direction thereof, a plurality of (e.g., two) outer elastic sheet sections 21. The outer elastic sheet section 21 is substantially fan-shaped when unfolded to a planar structure. The outer elastic sheet section 21 has an arc-shaped cross-section. The outer elastic sheet structure 2 has a thickness of 0.035 mm to 4.712 mm. When the thickness is less than 0.035 mm, the elasticity of the outer elastic sheet structure 2 is insufficient. When the thickness is more than 4.712 mm, the outer elastic sheet structure 2 is difficult to deform, more difficult to be processed, and has no practical production significance.

The inventor selects 11 groups of terminals having stamping elastic sheets, each group including 7 terminals, to test an elastic force of an outer elastic sheet strip 212 of each terminal.

The test method of the elastic force is to use a precise dynamometer to detect the elastic force generated by a single outer elastic sheet strip 212 or a single outer elastic strip sheet 22 when the outer elastic sheet strip 212 or the outer elastic strip sheet 22 is moved by 1 mm at the open end of the outer elastic sheet structure 2. In this embodiment, according to the number and thickness of the outer elastic sheet strip 212 or the outer elastic strip sheet 22, it is considered unqualified when the elastic force of the outer elastic sheet strip 212 or the outer elastic strip sheet 22 is less than 3 N or greater than TON. Because if the elastic force is small, a contact stress of the outer elastic sheet structure 2 on the mating terminal that is plugged with the outer elastic sheet structure 2 will be small, resulting in a decrease in a contact area and an increase in a contact resistance. If the elastic force is large, an insertion force of the out elastic sheet structure 2 on the mating terminal is large, resulting in the plugging and unplugging of the mating terminal being more difficult.

TABLE 1
Influences of Thickness and Number of the Outer Elastic Sheet Structures
2 on the Elastic Force of the Outer Elastic Sheet Strip 212

| | Thickness (mm) | | | | | | | | | | |
|---|---|---|---|---|---|---|---|---|---|---|---|
| | 0.020 | 0. 035 | 0.635 | 1.230 | 1.900 | 2.315 | 2.910 | 3.715 | 4.200 | 4.712 | 4.800 |
| Number | Elastic force (N) | | | | | | | | | | |
| 2 ↑ | 2.10 | 3.25 | 3.45 | 4.25 | 5.01 | 9.25 | 11.00 | 12.58 | 13.98 | 15.10 | 16.62 |
| 3 ↑ | 1.99 | 2.98 | 3.12 | 3.45 | 4.26 | 8.75 | 9.78 | 11.01 | 13.01 | 14.52 | 15.12 |
| 4 ↑ | 1.75 | 2.76 | 2.91 | 3.01 | 3.57 | 8.26 | 9.27 | 9.85 | 12.25 | 13.89 | 14.35 |
| 5 ↑ | 1.56 | 2.47 | 2.52 | 2.79 | 3.25 | 7.53 | 8.35 | 8.95 | 9.34 | 13.11 | 13.78 |
| 6 ↑ | 1.44 | 2.25 | 2.32 | 2.65 | 2.99 | 6.89 | 7.75 | 8.25 | 8.45 | 9.78 | 13.10 |
| 7 ↑ | 1.36 | 1.95 | 2.13 | 2.15 | 2.55 | 6.70 | 7.24 | 7.45 | 7.74 | 8.54 | 12.79 |
| 8 ↑ | 1.28 | 1.25 | 1.62 | 1.79 | 2.15 | 6.54 | 6.89 | 7.15 | 7.36 | 7.79 | 12.46 |

As can be seen from Table 1, a terminal having a stamping elastic sheet structure, which meets the elastic force requirement, can be obtained by selling the thickness and number of the outer elastic sheet structure 2. However, when the thickness of the outer elastic sheet structure 2 is less than 0.035 mm, the elastic force of the outer elastic sheet strip 212 is unqualified regardless of the number of the outer elastic sheet structure 2. Similarly, when the thickness of the outer elastic sheet structure 2 is greater than 4.712 mm, the elastic force of the outer elastic sheet strip 212 is unqualified regardless of the number of the outer elastic sheet structure 2. Therefore, the inventor selects the thickness of the outer elastic sheet structure 2 as 0.035 mm to 4.712 mm.

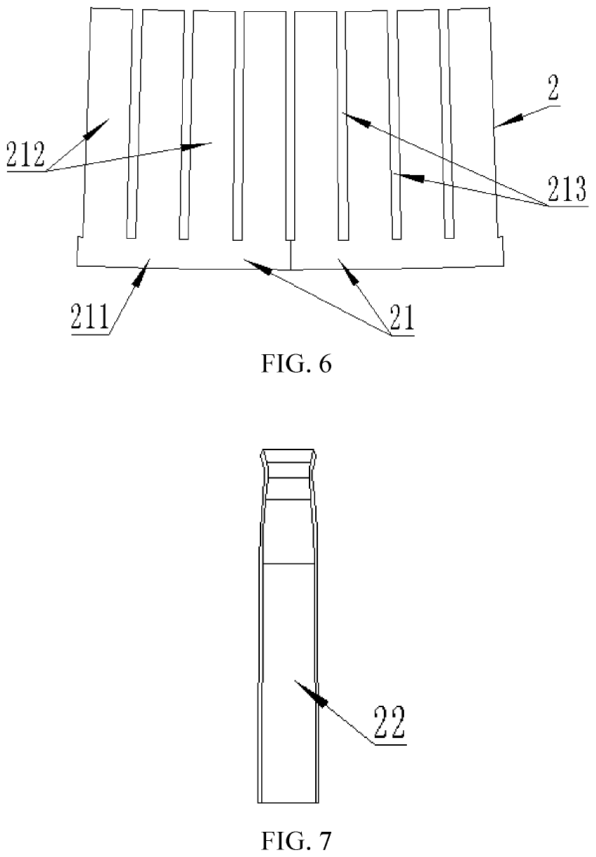

In this embodiment, the outer elastic sheet section 21 includes, in an axial direction of the outer elastic sheet structure 2, an outer connecting portion 211 and a plurality of outer elastic sheet strips 212, with an outer gap 213 formed between any two adjacent outer elastic sheet strips 212, as illustrated in FIG. 6. The outer elastic sheet strips 212 can adapt to the machining error of the mating terminal, so that a binding force between the outer elastic sheet strip 212 and the mating terminal is greater, the contact area therebetween is larger, and electrical and mechanical properties are improved, thereby solving the problem that the existing terminals cannot meet the mechanical demands and temperature rise requirements.

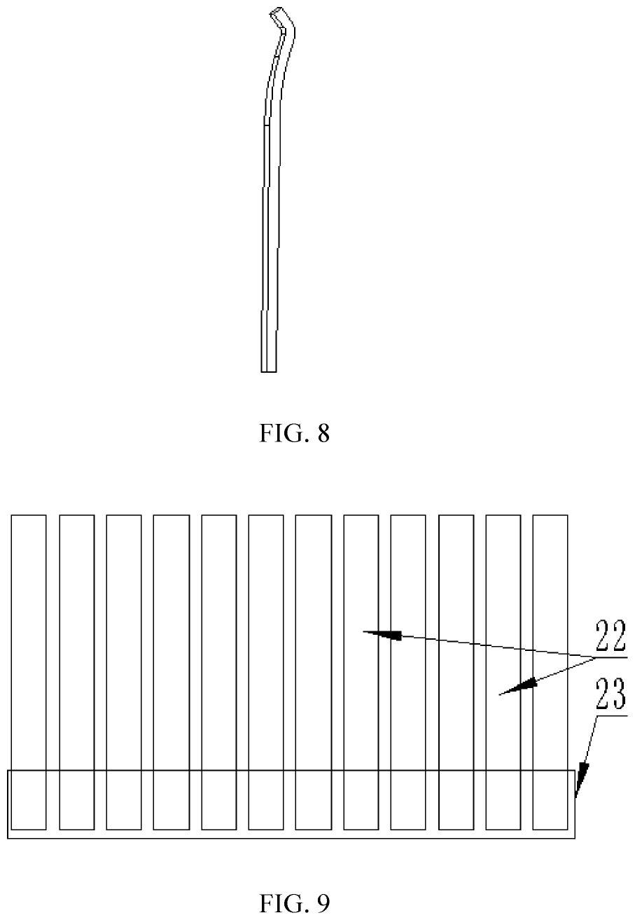

In this embodiment, as illustrated in FIGS. 7 and 8, the outer elastic sheet structure 2 is barrel-shaped, and includes, in a circumferential direction thereof, a plurality of independent outer elastic strip sheets 22. Such independent outer elastic strip sheets can be directly machined on a stamping machine or a rolling machine, which saves the material and allows machining with a raw material having a small width. When the outer elastic sheet structure 2 is damaged during use, only the damaged outer elastic sheet structure 2 needs to be replaced, instead of having to replace the whole terminal, so as to reduce the waste of the terminal, improve the maintenance efficiency, and greatly save costs.

In other embodiments, as illustrated in FIG. 9, the plurality of outer elastic strip sheets 22 are connected by an outer annular base strap 23, which is located at an end of the outer elastic sheet structure 2. The outer elastic strip sheets 22 are stacked with the outer annular base strap 23, and the outer annular base strap 23 is annular after being rolled, that is, the outer elastic sheet structure 2 illustrated in FIG. 9 can be rolled into a barrel-shaped structure. Although the independent outer elastic strip sheets 22 have the advantages of material saving and partial replacement in case of damage, when there are a large number of independent outer elastic strip sheets 22, the process of fixing the independent outer elastic strip sheets 22 on the base 1 respectively is complicated and takes a long time, which will limit the use of the independent outer elastic strip sheets 22. By disposing the outer annular base strap 23, the outer elastic strip sheets 22 may be stacked and fixed with the outer annular base strap 23 firstly, and then they are rolled into a barrel-shaped structure to be fixed with the base 1, which can greatly reduce the mounting time of the independent outer elastic strip sheets 22 and improve the assembly efficiency.

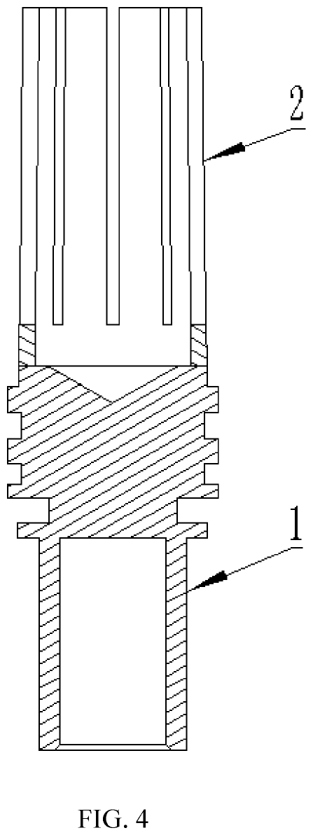

In this embodiment, since being barrel-shaped, the outer elastic sheet structure 2 includes an inner cavity which is taper-shaped, i.e., an inner diameter of one end of the outer elastic sheet structure 2 is larger than that of the other end thereof, as illustrated in FIG. 4. If an inner diameter of the inner cavity of the outer elastic sheet structure 2 is completely the same as an outer diameter of the mating terminal, due to a tolerance fit therebetween, the mating terminal might not be able to be inserted into the inner cavity or large areas of the mating terminal and the outer elastic sheet structure 2 might not be able to be in contact with other, resulting in a failure of electrical conduction or a small contact area. Therefore, the inventor sets the inner cavity of the outer elastic sheet structure 2 to be taper-shaped, so that the mating terminal can be inserted into the inner cavity while the outer elastic sheet structure 2 can have a larger deformation space, and a larger grasping force between the outer elastic sheet structure 2 and the mating terminal can be achieved when they are plugged with each other.

In this embodiment, an inner surface of the outer elastic sheet structure 2 may be provided with an outer arc-shaped constricted neck section 24 in a direction from one end of the outer elastic sheet structure 2 to the other end thereof. An inner diameter of the outer arc-shaped constricted neck section 24 is smaller than that of the outer elastic sheet structure 2, so that the inner surface of the outer arc-shaped constricted neck section 24 can always be in contact with the outer surface of the mating terminal. Meanwhile, when the mating terminal is plugged with the outer elastic sheet structure 2, an angle between the inner surface of the outer arc-shaped constricted neck section 24 and an axis of the terminal having a stamping elastic sheet structure is the same as that between the outer surface of the mating terminal and the axis, so that the inner surface of the outer arc-shaped constricted neck section 24 can be in surface contact with the outer surface of the mating terminal, which increases the contact area between the outer elastic sheet structure 2 and the mating terminal, reduces the contact resistance, improves the conductive performance of the terminal having a stamping elastic sheet structure, and improves the safety and stability of the electric device.

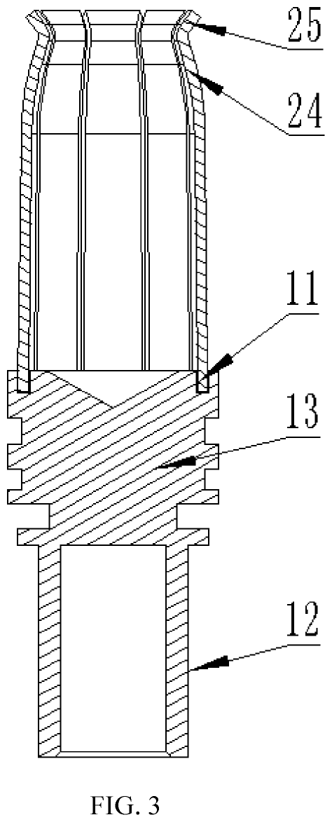

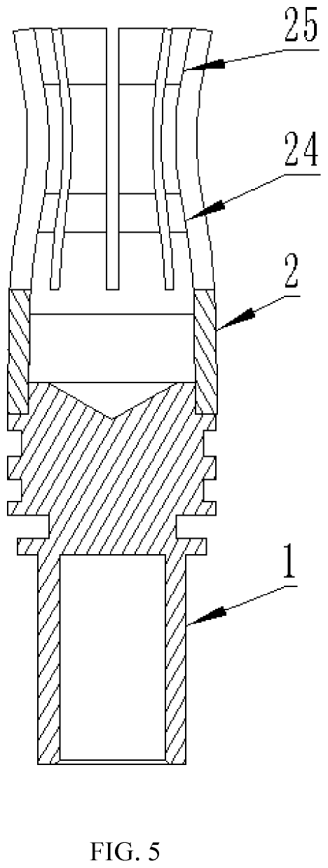

In order to facilitate the insertion of the mating terminal, the inner surface of the outer elastic sheet structure 2 may also be provided with an outer arc-shaped expanded neck section 25, that is, the inner surface of the outer elastic sheet structure 2 is provided with the outer arc-shaped constricted neck section 24 and the outer arc-shaped expanded neck section 25 in sequence in the direction from the one end of the outer elastic sheet structure 2 to the other end thereof, as illustrated in FIGS. 3 and 5. Since the inner cavity of the outer elastic sheet structure 2 is generally a tapered hole and an opening diameter of the inner cavity is smaller than the diameter of the mating terminal, the outer arc neck-expanded neck section 25 should be disposed inside an opening end of the inner cavity, so as to guide the insertion of the mating terminal to ensure a smooth insertion thereof, so that the mating terminal can expand the outer elastic sheet structure 2 and insert into the inner cavity thereof.

The outer arc-shaped constricted neck section 24 and the outer arc-shaped expanded neck section 25 are generally taper-shaped, and a taper of the outer arc-shaped constricted neck section 24 may be the same as that of the outer arc-shaped expanded neck section 25, as illustrated in FIG. 4. Alternatively, the taper of the outer arc-shaped constricted neck section 24 is smaller than that of the outer arc-shaped expanded neck section 25, the outer arc-shaped expanded neck section 25 is located at the other end of the outer elastic sheet structure 2, and the outer arc-shaped expanded neck section 25 is an outwardly flared structure, as illustrated in FIG. 3.

In this embodiment, an end of the mounting base is provided with a mounting groove, which is located at an outer side, an inner side or a middle of the end of the mounting base, and the outer elastic sheet structure is matched and butted with the mounting groove.

In this embodiment, the outer elastic sheet structure 2 may be detachably or non-detachably connected to the mounting base 1. Specifically, the outer elastic sheet structure 2 may be connected to the mounting base 1 by one or more selected from crimping, threaded connection, screw connection, bolt connection, snap-fit connection, bonding, welding and riveting.

When the outer elastic sheet structure 2 is connected to the mounting base 1 by crimping, an end of the mounting base 1 is provided with a mounting groove 11, which is located at an outer side (FIG. 5), an inner side or a middle (FIG. 3) of the end of the mounting base, and the outer elastic sheet structure 2 is matched and butted with the mounting groove 11. When the outer elastic sheet structure 2 is connected to the mounting base 1 by bonding or welding, the end of the mounting base 1 may not be provided with the mounting groove 11, as illustrated in FIG. 4.

During implementations, the outer elastic sheet structure 2 may be connected to the mounting base 1 by crimping or welding. When the outer connecting portion 211 of the outer elastic sheet structure 2 is circular-ring-shaped in the radial direction, the part of the outer connecting portion 21 and the part of the mounting base 1 that are sleeved with each other, or the part of each of the plurality of independent outer elastic strip sheets 22 of the outer elastic sheet structure 2 and the mounting groove on the mounting base 1 that are plugged with each other, may be connected by tin-plated crimping or welding to achieve a non-detachable connection.

During implementations, the outer elastic sheet structure 2 may be connected to the mounting base 1 by threads. When the outer connecting portion 211 of the outer elastic sheet structure 2 is circular-ring-shaped in the radial direction, an inner wall of the outer connecting portion 21 is provided with an internal thread sleeve, an outer wall of one end of the mounting base 1 is provided with an external thread, with the mounting base 1 being a hollow tubular structure or a solid column structure. Alternatively, when the outer connecting portion 211 of the outer elastic sheet structure 2 is circular-ring-shaped in the radial direction, an outer wall of the outer connecting portion 21 is provided with an external thread, an inner wall of one end of the mounting base 1 is provided with an internal thread, with the mounting base 1 being a hollow tubular structure. Therefore, a detachable connection can be achieved by a thread fit between the internal thread/external thread on one end of the outer elastic sheet structure 2 and the external thread/internal thread on one end of the mounting base 1, respectively.

During implementations, the outer elastic sheet structure 2 may be connected to the mounting base 1 by a screw, the screw has a screw head and a screw rod, and one end of the screw rod is a free end. When the outer connecting portion 211 of the outer elastic sheet structure 2 is circular-ring-shaped in the radial direction, a threaded hole for the screw rod to pass through is disposed at the part of the outer connecting portion 21 and the part of the mounting base 1 that are sleeved with each other. After the screw rod passes through the threaded hole, a nut is connected to the screw rod at the free end of the screw rod, so that the part of the outer elastic sheet structure 2 and the part of the mounting base 1 that are sleeved with each other can be fixed between the screw head and the nut, thereby achieving a detachable connection. During implementations, the outer elastic sheet structure 2 may be connected to the mounting base 1 by a screw. Alternatively, a plurality of screws may be disposed to pass through, from the side where the free ends of the screw rods is located, the parts of the plurality of independent outer elastic strip sheets 22 of the outer elastic sheet structure 2 and the part of the mounting groove on the mounting base 1 are plugged with each other, respectively, so that a non-detachable connection is achieved by an interference fitting between the screws, the elastic strip sheets 22 and the mounting base 1.

During implementations, the outer elastic sheet structure 2 may be connected to the mounting base 1 by a bolt. Specifically, the bolts pass through the parts of the plurality of independent outer elastic strip sheets 22 of the outer elastic sheet structure 2 and the part of the mounting groove on the mounting base 1 that are plugged with each other. One end of the bolt at the inner side of the mounting base 1 is in an interference connection, and the other end of the bolt at the outer side of the mounting base 1 is riveted, so as to achieve a non-detachable connection.

During implementations, the outer elastic sheet structure 2 may be connected to the mounting base 1 by a bolt. Specifically, the bolt passes through the part of the outer elastic sheet structure 2 and the part of the mounting base 1 that are sleeved with each other. Two end portions of the bolt, which are exposed from the parts of the outer elastic sheet structure 2 and the mounting base 1 that are sleeved with each other, are riveted, so as to achieve a non-detachable connection.

During implementations, the outer elastic sheet structure 2 may be connected to the mounting base 1 by bonding using a conductive adhesive, or the plurality of independent outer elastic strip sheets 22 of the outer elastic sheet structure 2 may be connected to the plugged mounting groove on the mounting base 1 by bonding using a conductive adhesive, so as to achieve a non-detachable connection between the outer elastic sheet structure 2 and the mounting base 1 and ensure a normal electric conduction of the terminal.

During implementations, the outer elastic sheet structure 2 may be connected to the mounting base 1 by riveting. Specifically, a rivet passes through the part of the outer elastic sheet structure 2 and the part of the mounting base 1 that are sleeved with each other. Two end portions of the rivet, which are exposed from the parts of the outer elastic sheet structure 2 and the mounting base 1 that are sleeved with each other, are riveted, so as to achieve a non-detachable connection by riveting.

During implementations, the outer elastic sheet structure 2 may be connected to the mounting base 1 by riveting. Specifically, rivets pass through the parts of the plurality of independent outer elastic rod sheets 22 of the outer elastic sheet structure 2 and the part of the mounting groove on the mounting base 1 that are plugged with each other. If the mounting base 1 is a hollow tubular structure, the rivets may pass through the parts of the plurality of independent outer elastic sheet strips 22 of the outer elastic sheet structure 2 and the part of the mounting grooves on the mounting base 1 that are plugged with each other. Two exposed end portions of the rivet can achieve a non-detachable connection by riveting.

The above connection modes may be used independently or in combination. For example, the threaded connection can be used in combination with a conductive adhesive connection, so as to achieve a more stable connection between the outer elastic sheet structure 2 and the mounting base 1.

In this embodiment, the mounting base 1 includes an electric energy transmission portion 12 and an outer-elastic-sheet connecting portion 13 which are connected in sequence. The electric energy transmission portion 12 is used for mounting and connecting a wire. The electric energy transmission portion 12 is a flat plate structure, a U-shaped structure, a major arc structure, a barrel structure, a cylindrical structure, a bowl structure, or a polygonal structure.

In some embodiments, the electric energy transmission portion 12 should be electrically connected to a wire, generally by crimping or welding process. Therefore, the electric energy transmission portion 12 may be designed into various structures, which may be selected according to the electrical connection requirements and the assembly environment of the electric device to establish a stable electrical connection with the wire. In general, the U-shaped structure, the major arc structure, the barrel structure, or the polygonal structure is suitable for crimping and welding, and the flat plate structure or the bowl structure is suitable for welding.

The outer-elastic-sheet connecting portion 13 serves to be mounted and connected with the outer elastic sheet structure 2, and matched and mounted with the electric device. According to the assembly demand, the outer-elastic-sheet connecting portion 13 may be externally provided with a plurality of annular grooves.

A manufacturing process of the terminal having a stamping elastic sheet structure will be described below.
1. The mounting base 1 is formed by turning, and the outer elastic sheet structure 2 is formed by stamping.
2. The mounting base 1 and the outer elastic sheet structure 2 are assembled into a whole by crimping, as illustrated in FIG. 5.

### Second Embodiment

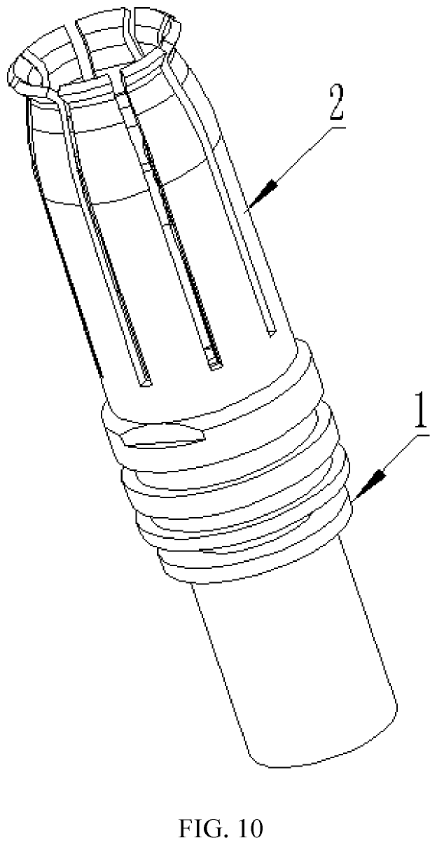

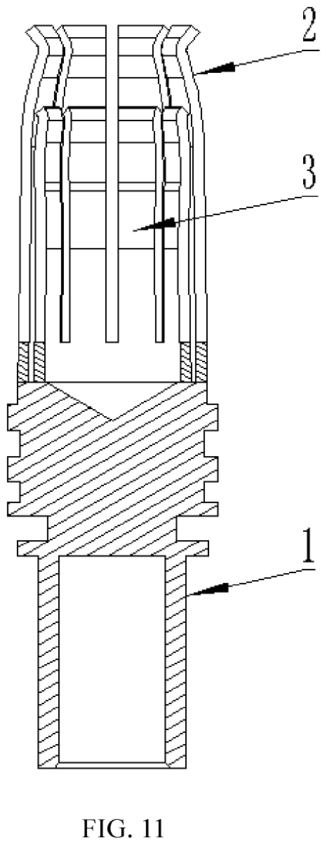

This embodiment is an improvement of the first embodiment, and it mainly differs from the first embodiment in that an inner elastic sheet structure 3 is added on the basis of the first embodiment, i.e., the terminal having the stamped elastic sheet structure further includes an inner elastic sheet structure 3, which is stacked with the outer elastic sheet structure 2. An end of the inner elastic sheet structure 3 is connected to the mounting base 1, or connected to the outer elastic sheet structure 2, or connected to both the mounting base 1 and the outer elastic sheet structure 2, as illustrated in FIGS. 10 and 11.

Since the outer elastic sheet structure 2 is generally formed by stamping, the thickness of the outer elastic sheet structure 2, which is limited by thickness of sheet material, may not meet the requirement of a gripping force between the terminal having a stamping elastic sheet structure and the mating terminal. Therefore, the inner elastic sheet structure 3 is disposed inside the outer elastic sheet structure 2 to improve the mechanical properties of the plugged terminals. Meanwhile, both the inner elastic sheet structure 3 and the outer elastic sheet structure 2 are electrically connected to the mating terminal, which increases the contact area between the terminal having a stamping elastic sheet structure and the mating terminal, and reduces the contact resistance of the plugged terminals, thereby facilitating the current conduction and the control of temperature rise, and greatly improving the electrical properties of the plugged terminals.

In this embodiment, the inner elastic sheet structure 3 is sleeved inside the outer elastic sheet structure 2, so that the contact area between the terminal having a stamping elastic sheet structure and the mating terminal is increased, without increasing the volume of the terminal having a stamping elastic sheet structure. The mounting base 1, the outer elastic sheet structure 2 and the inner elastic sheet structure 3 are formed separately, and the inner elastic sheet structure 3 is formed by stamping. Similarly, the inner elastic sheet structure 3 may also be formed by stamping a sheet material, thereby greatly reducing the usage amount of material for the terminal. In addition, in some embodiments, since the terminal having a stamping elastic sheet structure is of complex structure, the adoption of an integral machining method will lead to high cost and long machining time, so that different parts of the terminal having a stamping elastic sheet structure may be formed separately, and then the inner elastic sheet structure 3 and the outer elastic sheet structure 2 may be assembled with the mounting base 1 respectively, thereby improving the working efficiency and reducing the waste of materials.

In this embodiment, both the inner elastic sheet structure 3 and the outer elastic sheet structure 2 are barrel-shaped, and a length of the outer elastic sheet structure 2 is greater than that of the inner elastic sheet structure 3. Since both the inner elastic sheet structure 3 and the outer elastic sheet structure 2 should be electrically connected to the mating terminal, and the inner elastic sheet structure 3 is stacked with the outer elastic sheet structure 2, the length of the outer elastic sheet structure 2 should be greater than that of the inner elastic sheet structure 3, so that the mating terminal can be in contact with both the inner elastic sheet structure 3 and the outer elastic sheet structure 2 simultaneously.

In this embodiment, an axis of the outer elastic sheet structure 2 coincides with an axis of the inner elastic sheet structure 3. Since the outer elastic sheet structure 2 and the inner elastic sheet structure 3 are plugged with the same mating terminal, a male end of the mating terminal will be inserted into both the inner cavity of the outer elastic sheet structure 2 and the inner cavity of the inner elastic sheet structure 3 simultaneously, so that the axis of the outer elastic sheet structure 2 should coincide with the axis of the inner elastic sheet structure 3, and also coincide with an axis of the plugged mating terminal. The inner cavities of the outer elastic sheet structure 2 and the inner elastic sheet structure 3 are both taper-shaped. If an inner diameter of the inner cavity of the inner elastic sheet structure 3 is completely the same as an outer diameter of the mating terminal, due to a tolerance fit therebetween, the mating terminal might not be able to be inserted into the inner cavity of the inner elastic sheet structure 3 or large areas of the mating terminal and the inner elastic sheet structure 3 might not be able to be in contact with other, resulting in a failure of electrical conduction or a small contact area. Therefore, the inventor sets the inner cavities of the outer elastic sheet structure 2 and the inner elastic sheet structure 3 to be taper-shaped, so that the mating terminal can be inserted into the inner cavities while the outer elastic sheet structure 2 and the inner elastic sheet structure 3 can have a larger deformation space, and a larger grasping force between the outer elastic sheet structure 2 as well as the inner elastic sheet structure 3 and the mating terminal can be achieved when they are plugged with the mating terminal.

In this embodiment, a taper of the inner cavity of the outer elastic sheet structure 2 is smaller than that of the inner cavity of the inner elastic sheet structure 3. Since the outer elastic sheet structure 2 is located at the periphery of the inner elastic sheet structure 3, the taper of the inner cavity of the outer elastic sheet structure 2 is smaller than that of the inner cavity of the inner elastic sheet structure 3, so that the front ends of the outer elastic sheet structure 2 and the inner elastic sheet structure 3 can contact the mating terminal to realize an electrical conduction.

In this embodiment, the structure of the outer elastic sheet structure 2 and the structure of the inner elastic sheet structure 3 may be completely the same, partially the same or completely different. The outer elastic sheet structure 2 and the inner elastic sheet structure 3 may each adopt various structural forms as exemplified in the first embodiment, and may be selectively combined as required.

In this embodiment, the inner elastic sheet structure 3 is barrel-shaped, and includes, in the circumferential direction thereof, a plurality of inner elastic sheet sections 31. The inner elastic sheet section 31 has an arc-shaped cross-section, and has a thickness of 0.2 mm to 5 mm.

The inventor selects 11 groups of terminals having stamping elastic sheets, each group including 7 terminals, to test an elastic force of an inner elastic sheet strip 312 of each terminal.

The test method of the elastic force is to use a precise dynamometer to detect the elastic force generated by a single inner elastic sheet strip 312 or a single inner elastic strip sheet 32 when the inner elastic sheet strip 312 or the inner elastic strip sheet 32 is moved by 1 mm at the open end of the inner elastic sheet structure 3. In this embodiment, according to the number and thickness of the inner elastic sheet strip 312 or the inner elastic strip sheet 32, it is considered unqualified when the elastic force of the inner elastic sheet strip 312 or the inner elastic strip sheet 32 is less than 3 N or greater than ION. Because if the elastic force is small, a contact stress of the inner elastic sheet structure 3 on the mating terminal that is plugged with the inner elastic sheet structure 3 will be small, resulting in a decrease in a contact area and an increase in a contact resistance. If the elastic force is large, an insertion force of the inner elastic sheet structure 3 on the mating terminal is large, resulting in the plugging and unplugging of the mating terminal being more difficult.

TABLE 2
Influences of Thickness and Number of the Inner Elastic Sheet Structure
3 on the Elastic Force of the Inner Elastic Sheet Strip 312

| | Thickness (mm) | | | | | | | | | | |
|---|---|---|---|---|---|---|---|---|---|---|---|
| | 0.15 | 0.20 | 0.88 | 1.56 | 2.16 | 2.77 | 3.48 | 4.16 | 4.60 | 5.00 | 5.45 |
| Number | Elastic force (N) | | | | | | | | | | |
| 2 ↑ | 2.75 | 3.15 | 3.96 | 4.28 | 5.56 | 7.01 | 8.79 | 10.25 | 11.32 | 13.93 | 16.05 |
| 3 ↑ | 2.35 | 2.95 | 3.55 | 3.92 | 4.89 | 6.56 | 8.15 | 9.56 | 10.47 | 12.15 | 15.79 |
| 4 ↑ | 2.10 | 2.56 | 3.01 | 3.41 | 4.13 | 5.98 | 7.46 | 8.71 | 9.51 | 11.45 | 15.10 |
| 5 ↑ | 1.95 | 2.15 | 2.76 | 3.10 | 3.76 | 5.45 | 6.95 | 8.03 | 8.93 | 10.86 | 14.25 |
| 6 ↑ | 1.86 | 1.89 | 2.15 | 2.76 | 3.26 | 4.25 | 6.27 | 7.32 | 8.06 | 10.04 | 13.79 |
| 7 ↑ | 1.45 | 1.59 | 1.85 | 2.15 | 2.50 | 3.95 | 5.32 | 6.52 | 7.15 | 9.75 | 13.14 |
| 8 ↑ | 1.36 | 1.40 | 1.55 | 1.82 | 2.14 | 3.10 | 4.65 | 5.19 | 6.45 | 8.14 | 12.45 |

As can be seen from Table 2, a terminal having a stamping elastic sheet structure, which meets the elastic force requirement, can be obtained by setting the thickness and number of the inner elastic sheet structure 3. However, when the thickness of the inner elastic sheet structure 3 is less than 0.2 mm, the elastic force of the inner elastic sheet strip 312 is unqualified regardless of the number of the inner elastic sheet structure 3. Similarly, when the thickness of the inner elastic sheet structure 3 is greater than 5 mm, the elastic force of the inner elastic sheet strip 312 is unqualified regardless of the number of the inner elastic sheet structure 3. Therefore, the inventor selects the thickness of the inner elastic sheet structure 3 as 0.2 mm to 5 mm.

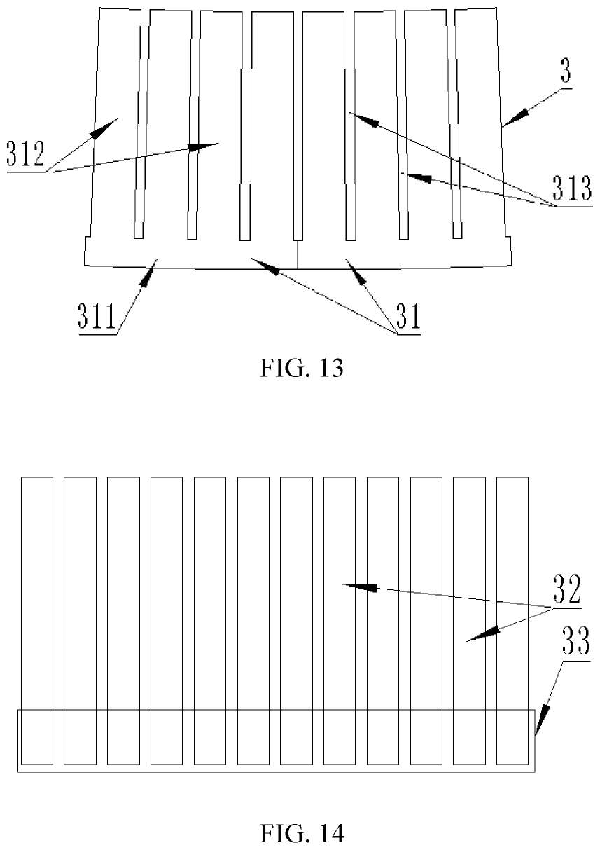

The inner elastic sheet section 31 includes, in an axial direction of the inner elastic sheet structure 3, an inner connecting portion 311 and a plurality of inner elastic sheet strips 312, with an inner gap 313 formed between any two adjacent inner elastic sheet strips 312, as illustrated in FIG. 13. The inner elastic sheet strips 312 can adapt to the machining error of the mating terminal, so that a binding force between the inner elastic sheet strip 312 and the mating terminal is greater, the contact area therebetween is larger, and electrical and mechanical properties are improved, thereby solving the problem that the existing terminals cannot meet the mechanical demands and temperature rise requirements.

Alternatively, the inner elastic sheet structure 3 is barrel-shaped, and includes, in a circumferential direction thereof, a plurality of independent inner elastic strip sheets 32. Such independent inner elastic strip sheets can be directly machined on a stamping machine or a rolling machine, which saves the material and allows machining with a raw material having a small width. When the inner elastic sheet structure 3 is damaged during use, only the damaged inner elastic sheet structure 3 needs to be replaced, instead of having to replace the whole terminal, so as to reduce the waste of the terminal, improve the maintenance efficiency, and greatly save costs.

The plurality of inner elastic strip sheets 32 are connected by an inner annular base strap 33. The inner elastic strip sheets 32 are stacked with the inner annular base strap 33, and the inner annular base strap 33 is located at an end of the inner elastic sheet structure 3, as illustrated in FIG. 14. Although the independent inner elastic strip sheets 32 have the advantages of material saving and partial replacement in case of damage, when there are a large number of independent inner elastic strip sheets 32, the process of fixing the independent inner elastic strip sheets 32 on the base 1 respectively is complicated and takes a long time, which will limit the use of the independent inner elastic strip sheets 32. By disposing the inner annular base strap 33, the inner elastic strip sheets 32 may be stacked and fixed with the inner annular base strap 33 firstly, and then they are rolled into a barrel-shape structure to be fixed with the base 1, which can greatly reduce the mounting time of the independent inner elastic strip sheets 32 and improve the assembly efficiency.

The inner elastic sheet structure 3 is barrel-shaped, and includes an inner cavity which is taper-shaped, i.e., an inner diameter of one end of the inner elastic sheet structure 3 is larger than that of the other end thereof. If an inner diameter of the inner cavity of the inner elastic sheet structure 3 is completely the same as an outer diameter of the mating terminal, due to a tolerance fit therebetween, the mating terminal might not be able to be inserted into the inner cavity or large areas of the mating terminals and the inner elastic sheet structure 3 might not be able to be in contact with other, resulting in a failure of electrical conduction or a small contact area. Therefore, the inventor sets the inner cavity of the inner elastic sheet structure 3 to be taper-shaped, so that the mating terminal can be inserted into the inner cavity while the inner elastic sheet structure 3 can have a larger deformation space, and a larger grasping force between the inner elastic sheet structure 3 and the mating terminal can be achieved when they are plugged with each other.

In this embodiment, an inner surface of the inner elastic sheet structure 3 may be provided with an inner arc-shaped constricted neck section 34 in a direction from one end of the inner elastic sheet structure 3 to the other end thereof. An inner diameter of the inner arc-shaped constricted neck section 34 is smaller than that of the inner elastic sheet structure 3, so that the inner surface of the inner arc-shaped constricted neck section 34 can always be in contact with the outer surface of the mating terminal. Meanwhile, when the mating terminal is plugged with the inner elastic sheet structure 3, an angle between the inner surface of the inner arc-shaped constricted neck section 34 and an axis of the terminal having a stamping elastic sheet structure is the same as that between the outer surface of the mating terminal and the axis, so that the inner surface of the inner arc-shaped constricted neck section 34 can be in surface contact with the outer surface of the mating terminal, which increases the contact area between the inner elastic sheet structure 3 and the mating terminal, reduces the contact resistance, improves the conductive performance of the terminal having a stamping elastic sheet structure, and improves the safety and stability of the electric device.

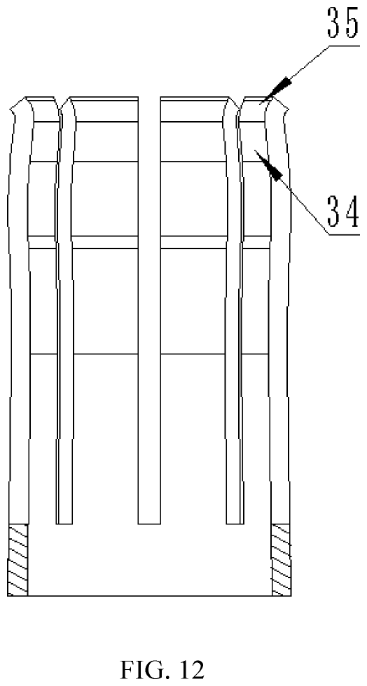

In this embodiment, the inner surface of the inner elastic sheet structure 3 may be provided with the inner arc-shaped constricted neck section 34 and the inner arc-shaped expanded neck section 35 in sequence in the direction from the one end of the inner elastic sheet structure 3 to the other end thereof, as illustrated in FIG. 12. Since the inner cavity of the inner elastic sheet structure 3 is generally a tapered hole and an opening diameter of the inner cavity is smaller than the diameter of the mating terminal, the inner arc-shaped expanded neck section 35 should be disposed inside an opening end of the inner cavity, so as to guide the insertion of the mating terminal to ensure a smooth insertion thereof, so that the mating terminal can expand the inner elastic sheet structure 3 and insert into the inner cavity thereof.

In this embodiment, an end of the mounting base 1 is provided with a mounting groove 11, which is located at an outer side, an inner side or a middle of the end of the mounting base 1. The outer elastic sheet structure 2 is plugged with the mounting groove 11. The inner elastic sheet structure 3 and the outer elastic sheet structure 2 may be plugged into the same mounting groove 11 or different mounting grooves 11.

In this embodiment, an end of the inner elastic sheet structure 3 may be connected to an end of the mounting base 1 or an end of the outer elastic sheet structure 2 by one or more selected from crimping, threaded connection, screw connection, bolt connection, snap-fit connection, bonding, welding and riveting.

Other technical features in this embodiment may be the same as those in the first embodiment, and here will not be described in detail in order to save space.

Those described above are merely specific embodiments of the present disclosure, rather than limitations thereto. Various modifications and variations can be made to the present disclosure by a person skilled in the art. Any modification, equivalent substitution, improvement, etc. made within the spirit and principle of the present disclosure should fall within the scope of the claims of the present disclosure.

1. A terminal having a stamping elastic sheet structure, comprising a mounting base and an outer elastic sheet structure, wherein an end of the outer elastic sheet structure is connected to an end of the mounting base, the mounting base and the outer elastic sheet structure are formed separately, and the outer elastic sheet structure is formed by stamping.

2. The terminal having a stamping elastic sheet structure according to claim 1, wherein:
the outer elastic sheet structure is barrel-shaped;
the outer elastic sheet structure comprises, in a circumferential direction thereof, a plurality of outer elastic sheet sections; and
each outer elastic sheet section has an arc-shaped cross-section, and has a thickness of 0.035 mm to 4.712 mm.

3. The terminal having a stamping elastic sheet structure according to claim 2, wherein the outer elastic sheet section comprises, in an axial direction of the outer elastic sheet structure, an outer connecting portion and a plurality of outer elastic sheet strips, with an outer gap formed between any two adjacent outer elastic sheet strips.

4. The terminal having a stamping elastic sheet structure according to claim 1, wherein:
the outer elastic sheet structure is barrel-shaped, and
the outer elastic sheet structure comprises, in a circumferential direction thereof, a plurality of independent outer elastic strip sheets.

5. The terminal having a stamping elastic sheet structure according to claim 4, wherein the plurality of outer elastic strip sheets are connected by an outer annular base strap, the outer elastic strip sheets are stacked with the outer annular base strap, and the outer annular base strap is located at the end of the outer elastic sheet structure.

6. The terminal having a stamping elastic sheet structure according to claim 1, wherein an inner cavity of the outer elastic sheet structure is taper-shaped, and an inner diameter of the end of the outer elastic sheet structure is larger than that of the other end of the outer elastic sheet structure.

7. The terminal having a stamping elastic sheet structure according to claim 1, wherein in a direction from the end of the outer elastic sheet structure to the other end thereof, an inner surface of the outer elastic sheet structure is provided with an outer arc-shaped constricted neck section, or is provided with an outer arc-shaped constricted neck section and an outer arc-shaped expanded neck section in sequence.

8-10. (canceled)

11. The terminal having a stamping elastic sheet structure according to claim 1, further comprising an inner elastic sheet structure, which is stacked with the outer elastic sheet structure, and an end of the inner elastic sheet structure is connected to the mounting base and/or the outer elastic sheet structure.

12. The terminal having a stamping elastic sheet structure according to claim 11, wherein the mounting base, the outer elastic sheet structure, and the inner elastic sheet structure are formed separately, and the inner elastic sheet structure is formed by stamping.

13. The terminal having a stamping elastic sheet structure according to claim 11, wherein both the outer elastic sheet structure and the inner elastic sheet structure are barrel-shaped, the inner elastic sheet structure is sleeved inside the outer elastic sheet structure, and a length of the outer elastic sheet structure is greater than that of the inner elastic sheet structure.

14. The terminal having a stamping elastic sheet structure according to claim 13, wherein an axis of the outer elastic sheet structure coincides with an axis of the inner elastic sheet structure, and an inner cavity of the outer elastic sheet structure and an inner cavity of the inner elastic sheet structure are both taper-shaped.

15. The terminal having a stamping elastic sheet structure according to claim 14, wherein a taper of the inner cavity of the outer elastic sheet structure is smaller than that of the inner cavity of the inner elastic sheet structure.

16. The terminal having a stamping elastic sheet structure according to claim 11, wherein:
the inner elastic sheet structure is barrel-shaped;
the inner elastic sheet structure comprises, in a circumferential direction thereof, a plurality of inner elastic sheet sections; and
each inner elastic sheet section has an arc-shaped cross-section, and has a thickness of 0.2 mm to 5 mm.

17. The terminal having a stamping elastic sheet structure according to claim 16, wherein the inner elastic sheet section comprises, in an axial direction of the inner elastic sheet structure, an inner connecting portion and a plurality of inner elastic sheet strips, with an inner gap formed between any two adjacent inner elastic sheet strips.

18. The terminal having a stamping elastic sheet structure according to claim 11, wherein:
the inner elastic sheet structure is barrel-shaped; and
the inner elastic sheet structure comprises, in a circumferential direction thereof, a plurality of independent inner elastic sheet strips.

19. The terminal having a stamping elastic sheet structure according to claim 18, wherein the plurality of inner elastic sheet strips are connected by an inner annular base strap, the inner elastic sheet strips is stacked with the inner annular base strap, and the inner annular base strap is located at the end of the inner elastic sheet structure.

20. The terminal having a stamping elastic sheet structure according to claim 11, wherein the inner elastic sheet structure is barrel-shaped, an inner cavity of the inner elastic sheet structure is taper-shaped, and an inner diameter of the end of the inner elastic sheet structure is larger than that of the other end of the inner elastic sheet structure.

21. The terminal having a stamping elastic sheet structure according to claim 11, wherein in a direction from the end of the inner elastic sheet structure to the other end thereof, an inner surface of the inner elastic sheet structure is provided with an inner arc-shaped constricted neck section, or is provided with an inner arc-shaped constricted neck section and an inner arc-shaped expanded neck section in sequence.

22. (canceled)

23. The terminal having a stamping elastic sheet structure according to claim 11, wherein:
the end of the mounting base is provided with a mounting groove, which is located at an outer side, an inner side or a middle of the end of the mounting base; and
the outer elastic sheet structure is plugged with the mounting groove, or matched and butted with the mounting groove.

24. The terminal having a stamping elastic sheet structure according to claim 11, wherein:
the outer elastic sheet structure is secured to the mounting base by one or more connections selected from the group consisting of crimping, a threaded connection, a screw connection, plugging, a bolt connection, a snap-fit connection, bonding, welding and riveting; and
the end of the inner elastic sheet structure is secured to the end of the mounting base by one or more connections selected from the group consisting of crimping, a threaded connection, a screw connection, plugging, a bolt connection, a snap-fit connection, bonding, welding and riveting.
